(19) United States
(12) Patent Application Publication
(10) Pub. No.: US 2025/0198216 A1
(43) Pub. Date: Jun. 19, 2025

(54) FURNITURE DRIVE FOR DRIVING A MOVABLE PIECE OF FURNITURE

(71) Applicant: Julius Blum GmbH, Hoechst (AT)

(72) Inventors: Bjoern GASSER, Mellau (AT); Alexander Peterlunger, Lustenau (AT); Klaus Mattle, Koblach (AT)

(21) Appl. No.: 19/072,109

(22) Filed: Mar. 6, 2025

Related U.S. Application Data
(63) Continuation of application No. PCT/AT2023/060299, filed on Aug. 30, 2023.

(30) Foreign Application Priority Data
Sep. 9, 2022 (AT) A 50687/2022

(51) Int. Cl. E05F 15/63; E05F 7/06

(52) U.S. Cl. CPC E05F 15/63; E05F 7/06; E05Y 2201/222; E05Y 2201/438; E05Y 2201/442; E05Y 2201/628; E05Y 2201/71; E05Y 2900/20

(57) ABSTRACT

A furniture drive for driving a movable piece of furniture includes an electric motor, an actuator which is preferably movable back and forth between two end positions for exerting force on the piece of furniture that is to be driven, and a gear mechanism connected between the electric motor and the actuator, and the electric motor is designed as an axial flux motor.

The present application is a continuation of International Application PCT/AT2023/060299 filed on Aug. 30, 2023. Thus, all of the subject matter of International Application PCT/AT2023/060299 is incorporated herein by reference.

### BACKGROUND OF THE INVENTION

The invention relates to a furniture drive for driving a movable furniture part, comprising at least one electric motor, at least one actuator, which is preferably movable back and forth between two end positions, for exerting force on the furniture part to be driven, and a gear mechanism connected between the electric motor and the actuator.

Such furniture drives with electric motors are known from the prior art. For example, they enable the automatic opening of a furniture part. Servo motors with a relatively slow speed are typically used hereby. The furniture drives have a relatively large design and, in the case of flap fittings, are attached to the flap fittings from the outside.

In recent years there have been efforts to reduce the construction of furniture drives so that they can also be arranged hidden in a wall of a piece of furniture.

This requires flat furniture drives and matching electric motors.

### SUMMARY OF THE INVENTION

The object of the present invention is to provide a particularly flat furniture drive.

According to the invention, the electric motor is designed as a disc motor. Disc motors can be designed to be particularly flat, which means that a particularly flat furniture drive can be realized. Since the coils and magnetic poles of disc motors can be arranged relatively far out, the ratio of torque to speed is large relative to other designs. In disc motors, at least one rotor and at least one stator are arranged at least partially axially offset from each other, like two axially offset disks.

In a preferred embodiment, at least one coupling device, preferably a belt, particularly preferably a toothed belt, and/or a gear, is provided, via which the electric motor, preferably a shaft of the electric motor or a pulley connected thereto, is connected to the gear mechanism.

Particularly preferably, the coupling device picks up the torque of the disc motor between coils and/or magnetic poles arranged on the stator or rotor and/or on a central shaft, preferably mounted on the stator or rotor, wherein it is preferably provided that the shaft has a smaller diameter than the stator and/or rotor. By using a coupling device, in particular a belt or a gear, the transmission of sound from the electric motor to the gear mechanism is reduced, even at high speeds. The coupling device can also function as the first gear stage.

Particularly preferably, the first gear stage, preferably all gear stages, are oriented eccentrically relative to the stator and/or the rotor and/or the central shaft and/or a motor axis.

The coupling device can be formed, at least in regions, by a sound-absorbing material, preferably wherein the sound-absorbing material of the coupling device is a rubber, caoutchouc, a plastic or an open- or closed-cell material, preferably a polyurethane elastomer, caoutchouc, silicone, EVA or PE foam and/or neoprene. The sound-absorbing material, especially neoprene, can be provided with a glass fiber tensile cord and special fabric to reduce noise and avoid dirty rubber output.

In a particularly preferred exemplary embodiment, the coupling device is designed as a belt. In particular, the belt and the electric motor can be arranged substantially in the same plane. This means that the belt does not add any additional width to the furniture drive. The belt can rest or can be attached to the shaft or a connected pulley within the electric motor. In particular, the shaft does not have to extend beyond the width of the electric motor. The belt is arranged or can be arranged partly in an intermediate space between two coils and/or magnetic poles of the electric motor, which is in particular designed as a disc motor.

Preferably, a first strand of the belt is arranged in a first intermediate space and a second strand of the belt is arranged in a second intermediate space different from the first intermediate space. At least one coil and/or at least one magnetic pole can be arranged between the first and second strands of the belt. This allows the belt to be routed from inside the electric motor. Alternatively, the belt can be attached to the outer diameter of the electric motor, in particular to the outer diameter of the rotor of the electric motor.

According to a preferred embodiment, the at least one electric motor is designed as a brushless motor, in particular as an EC motor with at least one electronic control unit for magnetic field commutation. Brushless motors have the advantage that they are quieter and require less maintenance than motors with brushes. Brushless motors can be understood as motors without a transfer of current to the rotor of the electric motor. Typically, only passive elements, such as permanent magnets, are arranged on the rotor. The current-carrying elements, such as coils, are arranged on the stator. The magnetic field is typically commutated by means of an electronic control unit (EC motor). The abbreviation “EC” in the term “EC motor” means “electronically commuted”, which refers to the electronically controlled magnetic field commutation.

In a preferred exemplary embodiment, the electric motor may have a width of less than 16 millimeters, preferably less than 10 millimeters, and particularly preferably less than or equal to 8 millimeters. The electric motor is therefore particularly flat. “Width” refers in particular to the total width of the electric motor including any shaft for the output. The electric motor is therefore flat overall and can preferably be housed entirely in a flat housing. It can be provided that the electric motor has a diameter of less than 90 millimeters, preferably less than or equal to 80 millimeters.

The electric motor may have a holding torque and/or a maximum torque of less than or equal to 0.3 Newton meters, preferably when a voltage of less than or equal to 50 volts is applied.

In a preferred exemplary embodiment, the disc motor is designed as an axial flux motor. The magnetic flux is therefore axially aligned. The disc motor can have a rotor with, preferably at least 4, particularly preferably exactly 8, magnetic poles. However, fewer or more magnetic poles are also conceivable. The rotor may be disk-shaped, with the magnetic poles arranged on one side of the disk. The disc motor can have a stator with preferably at least 3, particularly preferably exactly 6, coils. However, fewer or more coils are also conceivable.

The stator can be disc-shaped. The stator can also surround the rotor on both sides. Coils, preferably core-less, are arranged on the stator. In addition, a coil can be assigned a flux conduction part, preferably made of a sintered material, with which the magnetic flux can be conducted.

In a preferred exemplary embodiment, the axis of rotation of the electric motor is aligned substantially parallel to the axis of rotation of at least one element, preferably all elements, of the gear mechanism. An electric motor that is flat in the direction of the axis of rotation does not widen the furniture drive.

Preferably, the furniture drive can have at least one housing. The gear mechanism and the electric motor can be arranged in the housing.

The furniture drive can have at least one bearing device, via which the electric motor is mounted in and/or on the housing, wherein the at least one bearing device comprises at least one damping element made of a sound-absorbing material. This also reduces the transmission of sound from the electric motor to the housing.

Preferably, the at least one bearing device has at least one bearing part connected to the electric motor, preferably wherein the bearing part is designed as a steel axle, rivet or pin. At least one first damping element and at least one second damping element can be arranged on the bearing part, and the first damping element is arranged in such a way that it reduces sound propagation between the electric motor and the housing in a first spatial direction, and the second damping element is arranged in such a way that sound propagation between the electric motor and the housing is reduced in a second spatial direction transverse to the first spatial direction. The first and/or the second damping element is designed as a damping disc or damping sleeve.

In particular, more than one, preferably three, bearing devices can be provided, via which the electric motor is mounted in and/or on the housing.

In a preferred exemplary embodiment, at least one transmission device is provided with which the gear mechanism is connected to the actuator. The transmission device preferably comprises at least one lever.

In one exemplary embodiment, the electric motor and the gear mechanism are arranged in a first housing and the actuator is arranged in a second housing that is structurally separate from the first housing. It is preferably provided that the two housings are arranged one above the other in a coupled state essentially in a common plane. This does not increase the width of the furniture drive.

At least one lever arrangement can be provided, via which the actuator is pivotally connected to the housing.

At least one mechanical energy accumulator can be provided, with which a force for compensating the weight of the furniture part to be driven can be exerted on the actuator. The actuator can be arranged substantially completely in the housing in a first end position.

Preferably, the housing has a maximum width of less than 18 mm, preferably less than 16 mm.

A piece of furniture, preferably an upper cabinet, includes at least one movable furniture part, preferably in the form of a flap that can be opened upwards, and at least one furniture drive as described above, wherein the furniture part is movably mounted on the piece of furniture via the at least one furniture drive.

In a preferred embodiment, the piece of furniture comprises at least one wall, wherein the housing of the at least one furniture drive is substantially completely inserted into a recess in the wall.

### BRIEF DESCRIPTION OF THE DRAWINGS

Further details and embodiments are shown in the figures, in which:

FIGS. 1, 2 show a piece of furniture according to an exemplary embodiment in a perspective view (FIG. 1), and in an exploded view (FIG. 2),

FIG. 3 shows a furniture drive according to an exemplary embodiment without a housing cover in a plan view from the side,

FIGS. 4a, 4b show a housing without housing cover with gear mechanism and electric motor in perspective view and side view,

FIG. 5 shows a housing cover with gear mechanism and electric motor in a perspective view,

FIG. 6 shows a housing with gear mechanism and electric motor in exploded view,

FIG. 7 shows a housing for gear mechanism and electric motor in closed state,

FIGS. 8a, 8b show the gear mechanism and electric motor in a side view, opaque and transparent,

FIGS. 9a, 9b show the gear mechanism and the electric motor in an alternative side view, opaque and transparent,

FIGS. 10a, 10b show the housing without a housing cover with gear mechanism and electric motor with worm gear in perspective view and perspective detailed view,

FIGS. 11a, 11b show the housing without a housing cover with gear mechanism and electric motor with worm gear in side view and detailed view,

FIG. 12a shows the disc motor in perspective view,

FIG. 12b shows the disc motor in exploded view, and

FIG. 13 shows the disc motor with belt in the same plane.

### DETAILED DESCRIPTION OF THE INVENTION

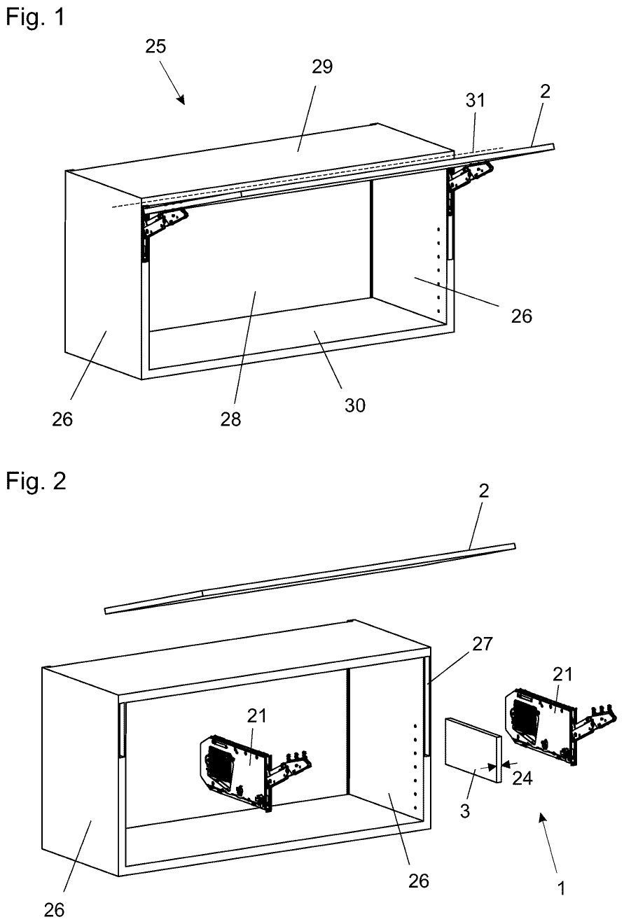

FIGS. 1 and 2 show a piece of furniture 25 in the form of an upper cabinet, comprising a movable furniture part 2 in the form of a flap that can be opened upwards and furniture drives 1, wherein the furniture part 2 is movably mounted on the piece of furniture 25 via the furniture drives 1. The furniture part 2 can be pivoted about a horizontal axis 31.

The piece of furniture 25 can comprise a rear wall 28, an upper shelf 29 and a lower shelf 30, as in the case shown, and can comprise walls 26, wherein housings 3, 21 of the furniture drives 1 are each inserted substantially completely into a recess 27 in the walls 26. The housings 3, 21 preferably have a maximum width 24 of less than 18 mm, preferably less than 16 mm.

An electric motor 4 is arranged in the housing 3, which is only shown schematically in FIG. 2. In particular, the actuator 7, which is connected or connectable to the furniture part 2, is pivotally arranged on the housing 21. However, not all furniture drives 1 have to be provided with an electric motor drive unit. In the case shown, only one of the furniture drives 1 has an electric motor drive unit.

Alternative designs of a furniture are conceivable in which the furniture drives 1 according to the invention are used.

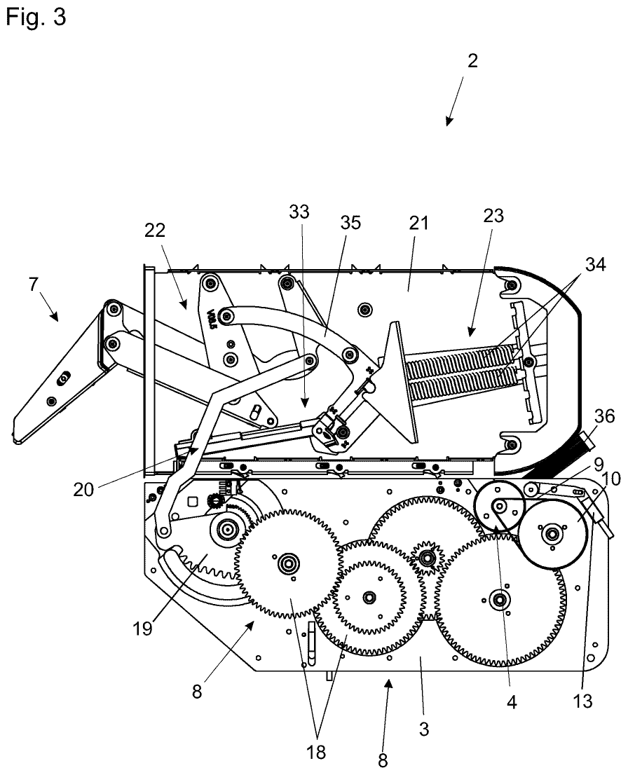

FIG. 3 shows a furniture drive 1 for driving a movable furniture part 2, which has at least one electric motor 4, at least one actuator 7, which can preferably be moved back and forth between two end positions, for exerting force on the furniture part 2 to be driven, and a gear mechanism 8 connected between the electric motor 4 and the actuator 7.

At least one belt 9, preferably a toothed belt, is provided, via which the electric motor 4, preferably a shaft 11 of the electric motor 4 or a pulley 12 connected thereto, is connected to the gear mechanism 8. In particular, the belt 9 is connected to a second pulley 10 of the gear mechanism 8. The belt 9 can be tensioned by means of a preferably pivotable belt tensioner 13, which engages in the belt 9, for example by means of a roller.

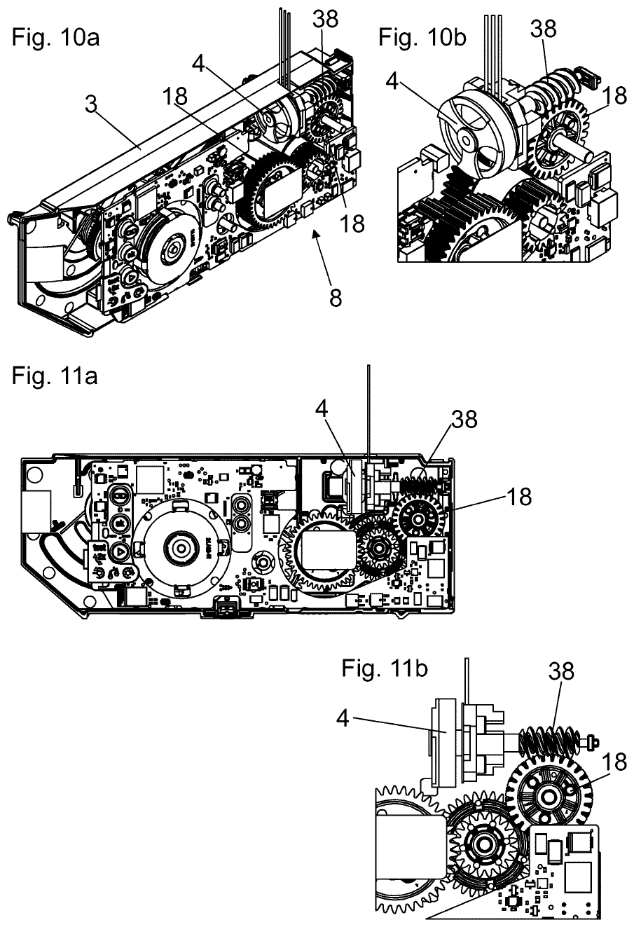

Alternatively or additionally, the electric motor 4 can be mounted so that it can be displaced, whereby the belt 9 can be tensioned by displacing the electric motor 4. Instead of the belt 9, another coupling device can be provided between the electric motor 4 and the gear mechanism 8, for example a gear or worm gear 38 (see FIGS. 10a to 11b). The electric motor 4 can be designed as a disc motor 45. The electric motor 4 and the gear mechanism 8 can be arranged in a first housing 3, as in the case shown, and the actuator 7 can be arranged in a second housing 21 that is structurally separate from the first housing 3, preferably wherein the two housings 3, 21 are arranged one above the other in a coupled state essentially in a common plane.

At least one transmission device 20 is provided, with which the gear mechanism 8 is connected to the actuator 7, and the transmission device 20 comprises at least one lever. Alternative embodiments of the transmission device 20 are also conceivable. In particular, the transmission device 20 is coupled to the gear mechanism 8 via a non-circular gear 19.

At least one lever arrangement 22 is provided, via which the actuator 7 is pivotally connected to the housing 21. In the specific case, the lever arrangement 22 forms a 7-joint arrangement. At least one mechanical energy accumulator 23 is provided, with which a force for compensating the weight of the furniture part 2 to be driven can be exerted on the actuator 7. The mechanical energy accumulator 23 can have one or more compression springs 34.

A force transmission lever 35 can be provided to transmit a force stored in the mechanical energy accumulator 23 to the actuator 7. Furthermore, a force adjustment device 33 can be provided, which can preferably be actuated from a front side of the housing 21 and with which a spring preload of the springs 34 can be adjusted. In a first end position, which corresponds to a closed position of the furniture part 2, the actuator 7 is arranged essentially completely in the housing 21. The gear mechanism 8 comprises multiple gear stages 32, in which an overload and/or a freewheel clutch can also be integrated. The gear stages 32 can be formed by gears 18 of different sizes.

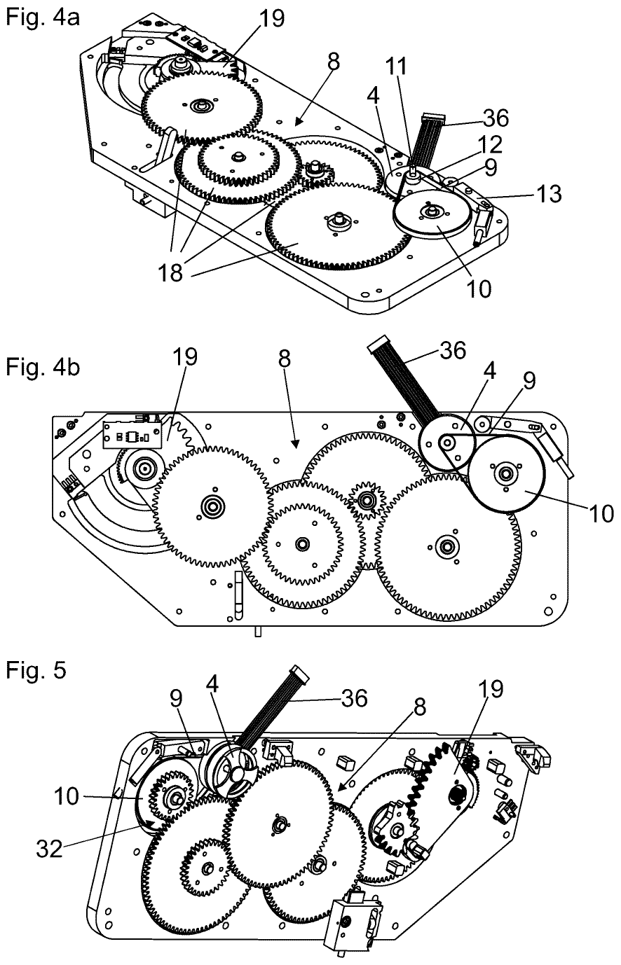

FIG. 4a shows an electromotive drive unit with a housing 3 without housing cover, gear mechanism 8 and electric motor 4 in a perspective view. FIG. 4b shows a corresponding side view. The axis of rotation of the electric motor 4 is aligned substantially parallel to the axis of rotation of at least one element, preferably all elements, of the gear mechanism 8, in particular the gears 18. In such an installation position, axially flat electric motors 4 require little space in the width of the furniture drive 1 and thus allow the realization of a flat furniture drive 1.

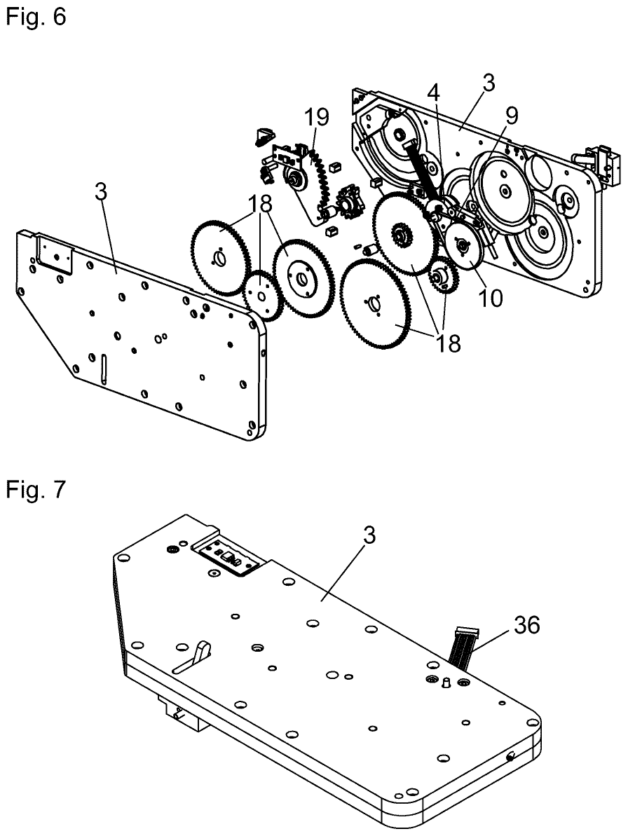

FIG. 5 shows the missing part of the housing 3 not shown in FIGS. 4a and 4b and the gear mechanism 8 and the electric motor 4 from the other side compared to FIGS. 4a and 4b. FIG. 6 shows the housing 3, the gear mechanism 8 and the electric motor 4 in an exploded view. FIG. 7 shows the closed housing 3.

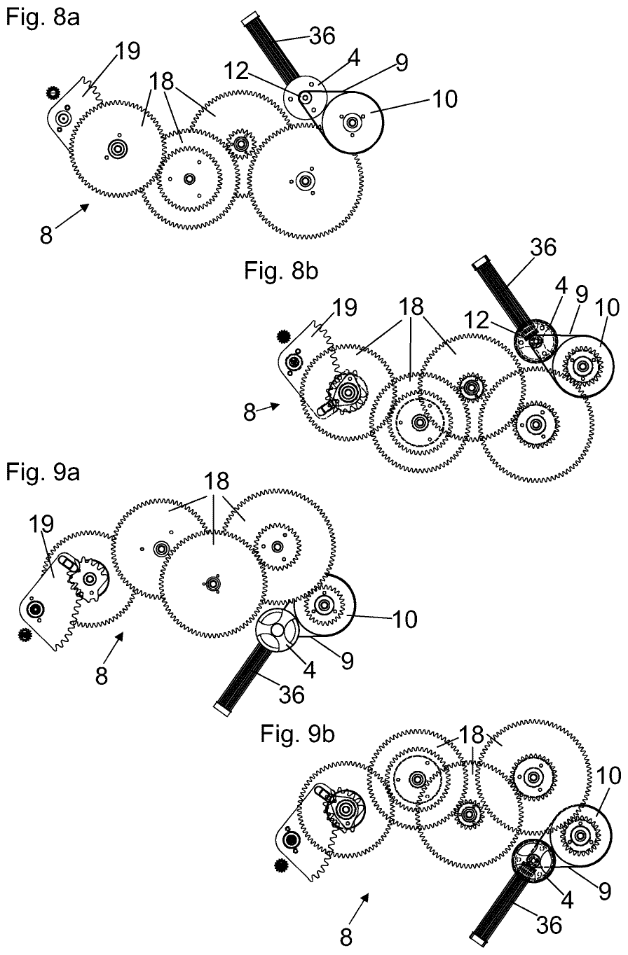

FIGS. 8a to 9b show the gear mechanism 8 and the electric motor 4 without the housing 3. FIGS. 8a and 8b show the gear mechanism 8 and the electric motor 8 from a first side, FIGS. 9a and 9b show the gear mechanism and the electric motor 8 from a second side. FIGS. 8b and 9b do not show the gears 18 in a opaque manner, whereby the design of the gear stages 32 is apparent. The gear mechanism 8 reduces the rotation speed. The fastest rotating part, the electric motor 4, is the loudest due to its high speed and should be decoupled.

A reduction in the transmission of sound to the gear mechanism 8 is achieved in this embodiment by the fact that the first gear stage is operated by means of the belt 9. It can be provided that the belt 9 consists at least in regions of a sound-absorbing material, preferably wherein the sound-absorbing material of the belt 9 is a rubber, a caoutchouc, a plastic, or an open- or closed-cell material, preferably a polyurethane elastomer, rubber, silicone, EVA or PE foam and/or neoprene. A reduction of the sound propagation to the housing 3 can be achieved if the furniture drive has at least one bearing device, via which the at least one electric motor 4 is mounted in and/or on the housing 3, wherein the at least one bearing device can comprise at least one damping element made of a sound-absorbing material.

FIGS. 10a to 11b show an alternative embodiment in which the first gear stage is realized by means of a worm gear 38. A disadvantage of this exemplary embodiment is that sound from the electric motor 4 is more likely to be transmitted to the gear mechanism 8 via the worm gear 38. In FIGS. 10a to 11b, the axis of rotation of the electric motor 4 is not aligned parallel to the axis of rotation of the elements of the gear mechanism 8. In order to realize a flat furniture drive, the electric motor 4 must have a small diameter.

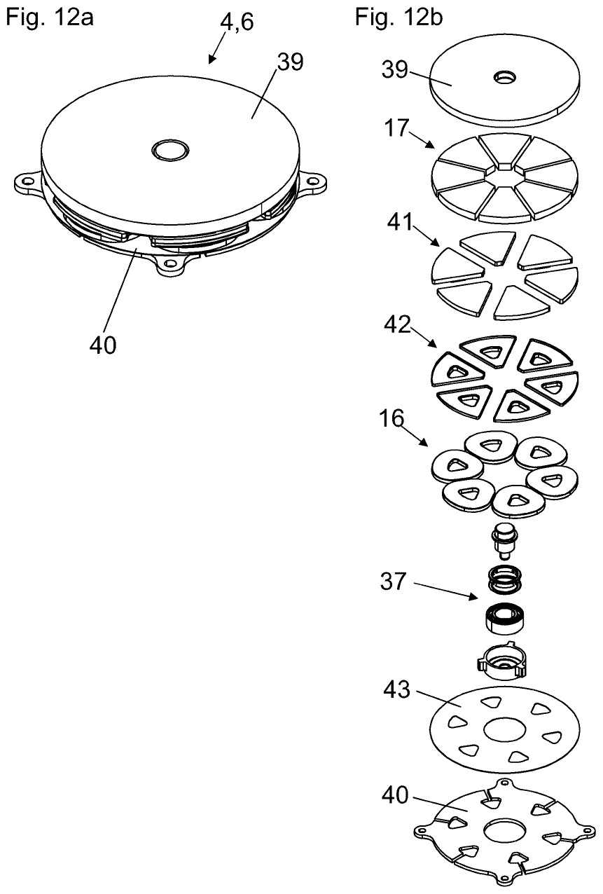

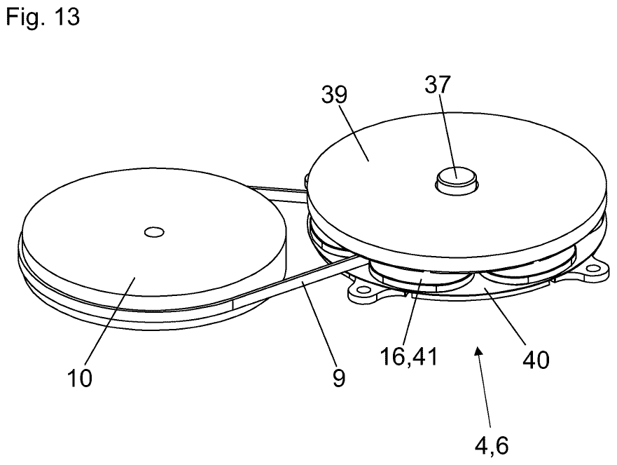

FIGS. 12a and 12b show an exemplary embodiment of a flat disc motor 6 according to the invention. The rotor 39 and the stator 40 are essentially disc-shaped and arranged axially offset from one another. As can be seen from the exploded view in FIG. 12b, eight magnetic poles 17 are arranged on the rotor 39. However, a different number of magnetic poles 17 is also conceivable. A coil carrier 43 is provided on the stator 40, with six coils 16 arranged on the coil carrier 43. However, a different number of coils 16 is also conceivable. In this exemplary embodiment, the coils 16 are designed to be core-less.

A flux guide part 42 can be arranged axially offset on each coil 16, can have essentially the shape of a disk segment with a hole, can consist of a sintered material, and/or can serve to conduct the magnetic flux.

A coil cover 41 is arranged above the coils 16 and the flux guide parts 42, wherein preferably a separate coil cover 41 is provided for each coil-flux guide pair. The disc motor 6 is designed as an axial flux motor. Due to the arrangement of the coils 16, the magnetic flux therefore runs in the direction of the axis of rotation of the disc motor 6.

Since only passive magnetic poles 17 are arranged on the rotor 39, the disc motor 6 can be designed brushless. Preferably, the disc motor 6 is designed as an EC motor (EC means “electronically commutated”) with an electronic control unit for commutating the magnetic field. The coils 16 are controlled via power and signal lines 36, which are not shown in FIGS. 12a and 12b (but see, for example, FIGS. 4a to 5). Sensors, such as Hall sensors, can also be provided in the electric motor 4, for example to determine the position of the rotor 39. The rotor 39 and the stator 40 are connected to each other via a bearing 37.

The shaft 11, via which the output takes place and on which, for example, the pulley 12 is arranged, can project axially beyond the rotor 39 and/or the stator 40, as in FIGS. 3 to 8b. The belt 9 must thus be arranged axially offset to the electric motor 4. A disadvantage of this embodiment is that the belt 9 contributes to the minimum width of the furniture drive 1.

In the exemplary embodiment of FIG. 13, the belt 9 and the electric motor 4 are arranged substantially in the same plane. In particular, the belt 9 is or can be applied to the shaft 11 or a pulley 12 connected thereto within the electric motor 4. The belt 9 is partially arranged in an intermediate space between at least two coils 16 arranged on the stator 40 of the electric motor 4 designed as a disc motor 6. Thus, the belt 9 can be guided from the inside of the electric motor 4 to the outside to a second pulley 10. In particular, a first strand of the belt 9 is arranged in a first intermediate space and a second strand of the belt 9 is arranged in a second intermediate space different from the first intermediate space. A coil 16, in particular including a coil cover 41, is arranged between the two strands.

The electric motor 4, in particular the disc motor 6 shown in FIGS. 12a to 13, can have the following properties:
a width of less than 16 millimeters, preferably less than 10 millimeters and particularly preferably less than or equal to 8 millimeters, and/or
a diameter of less than 90 millimeters, preferably less than or equal to 80 millimeters, and/or
a holding torque and/or a maximum torque of less than or equal to 0.3 Newton meters, preferably when a voltage of less than or equal to 50 volts is applied.

### LIST OF REFERENCE NUMERALS

1 furniture drive
2 furniture part
3 housing
4 electric motor
6 disc motor
7 actuator
8 gear mechanism
9 belt
10 second pulley
11 shaft
12 pulley
13 belt tensioner
16 coil
17 magnetic pole
18 gears
19 non-circular gear
20 transmission device
21 housing
22 lever arrangement
23 mechanical energy accumulator
24 maximum width
25 piece of furniture
26 wall
27 recess
28 rear wall
29 upper shelf
30 lower shelf
31 horizontal axis
32 gear stages
33 force adjustment device
34 compression spring
35 force transmission lever
36 power and signal lines
37 bearing
38 worm gear
39 rotor
40 stator
41 coil cover
42 flux guide parts
43 coil carrier

1. A furniture drive for driving a movable furniture part, comprising:
at least one electric motor,
at least one actuator, preferably movable back and forth between two end positions, for exerting force on the furniture part to be driven, and
a gear mechanism connected between the electric motor and the actuator,
wherein the electric motor is designed as a disc motor.

2. The furniture drive according to claim 1, further comprising at least one coupling device, preferably a belt, particularly preferably a toothed belt, and/or a gear, via which the electric motor, preferably a shaft of the electric motor or a pulley connected thereto, is connected to the gear mechanism.

3. The furniture drive according to claim 2, wherein the coupling device is designed as a belt, wherein:
the belt and the electric motor are arranged substantially in the same plane, and/or
the belt is or can be applied to the shaft or to a belt pulley connected thereto within the electric motor, and/or
the belt is arranged or can be arranged partly in an intermediate space between coils and/or magnetic poles of the electric motor arranged on the stator, preferably wherein a first strand of the belt is arranged or can be arranged in a first intermediate space and a second strand of the belt is arranged or can be arranged in a second intermediate space different from the first intermediate space.

4. The furniture drive according to claim 1, wherein the at least one electric motor is designed as a brushless motor, in particular as an EC motor with at least one electronic control unit for magnetic field commutation.

5. The furniture drive according to claim 1, wherein the electric motor:
has a width of less than 16 millimeters, preferably less than 10 millimeters, and particularly preferably less than or equal to 8 millimeters, and/or
has a diameter of less than 90 millimeters, preferably less than or equal to 80 millimeters, and/or
has a holding torque and/or a maximum torque of less than or equal to 0.3 Newton meters, preferably when a voltage of less than or equal to 50 volts is applied.

6. The furniture drive according to claim 1, wherein the disc motor:
is designed as an axial flux motor, and/or
has a rotor with, preferably at least 4, particularly preferably exactly 8, magnetic poles, and/or
has a stator with preferably at least 3, particularly preferably exactly 6, coils.

7. The furniture drive according to claim 1, wherein the axis of rotation of the electric motor is aligned substantially parallel to the axis of rotation of at least one element, preferably all elements, of the gear mechanism.

8. The furniture drive according to claim 1, wherein the coupling device is formed at least in regions by a sound-damping material, wherein the sound-absorbing material of the coupling device is a rubber, a caoutchouc, a plastic, or an open-cell or closed-cell material, preferably a polyurethane elastomer, caoutchouc, silicone, EVA or PE foam and/or neoprene.

9. The furniture drive according to claim 1, further comprising at least one housing.

10. The furniture drive according to claim 9, wherein the furniture drive has at least one bearing device via which the electric motor is mounted in and/or on the housing, wherein the at least one bearing device comprises at least one damping element made of a sound-absorbing material, preferably wherein the at least one bearing device has at least one bearing part connected to the electric motor, preferably wherein the bearing part is designed as a steel axle, rivet or pin.

11. The furniture drive according to claim 1, wherein at least one transmission device is provided, with which the gear mechanism is connected to the actuator, preferably wherein the transmission device comprises at least one lever.

12. The furniture drive according to claim 1, wherein the electric motor and the gear mechanism are arranged in a first housing and the actuator is arranged on a second housing which is structurally separate from the first housing, preferably wherein the two housings are arranged in a coupled state substantially in a common plane one above the other.

13. The furniture drive according to claim 1, wherein:
at least one lever arrangement is provided, via which the actuator is pivotally connected to the housing, and/or
at least one mechanical energy accumulator is provided, with which a force for compensating the weight force of the furniture part to be driven, can be exerted on the actuator, and/or
the actuator is arranged substantially completely in the housing in a first end position.

14. The furniture drive according to claim 1, wherein the housing has a maximum width of less than 18 mm, preferably less than 16 mm.

15. A piece of furniture, preferably an upper cabinet, comprising:
at least one movable furniture part, preferably in the form of a flap that can be opened upwards, and
the furniture drive according to claim 1,
wherein the furniture part is movably mounted on the piece of furniture via the at least one furniture drive.

16. The piece of furniture according to claim 15, wherein the piece of furniture comprises at least one wall, wherein the housing of the at least one furniture drive is substantially completely inserted into a recess in the wall.
